(19) United States
(12) Patent Application Publication
(10) Pub. No.: US 2016/0338032 A1
(43) Pub. Date: Nov. 17, 2016

(54) RESOURCE ALLOCATION AND MESSAGE IDENTIFICATION OF CONTROL SIGNALS IN CELLULAR SYSTEMS

(71) Applicant: QUALCOMM Incorporated, San Diego, CA (US)

(72) Inventors: Xiao Feng WANG, San Diego, CA (US); Mungal Singh DHANDA, Slough (GB); Junyi LI, Chester, NJ (US)

(21) Appl. No.: 14/885,028

(22) Filed: Oct. 16, 2015

Related U.S. Application Data
(60) Provisional application No. 62/159,590, filed on May 11, 2015.

(51) Int. Cl. H04W 72/04

(52) U.S. Cl. CPC H04W 72/0406

(57) ABSTRACT

A method, an apparatus, and a computer-readable medium for wireless communication are provided. The apparatus retrieves a particular number corresponding to a UE. To retrieve the particular number, the apparatus may receive the particular number through a channel request from the UE. Alternately, the apparatus may assign the particular number to the UE in order to retrieve the particular number. The apparatus determines a resource block within a coverage class based on the particular number. To determine the resource block, the apparatus maps the particular number to a resource block number within the coverage class using a hash function. The resource block number identifies the resource block. The apparatus transmits a device-specific control message to the UE using the determined resource block.

### CROSS-REFERENCE TO RELATED APPLICATION

This application claims the benefit of U.S. Provisional Application Ser. No. 62/159,590, entitled “RESOURCE ALLOCATION AND MESSAGE IDENTIFICATION OF CONTROL SIGNALS IN CELLULAR SYSTEMS” and filed on May 11, 2015, which is assigned to the assignee hereof and expressly incorporated herein by reference in its entirety.

### BACKGROUND

1. Field

The present disclosure relates generally to communication systems, and more particularly, to a resource allocation and message identification of control signals.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a method, a computer-readable medium, and an apparatus for wireless communication are provided. The apparatus retrieves a particular number corresponding to a UE. The apparatus determines a resource block within a coverage class based on the particular number. To determine the resource block, the apparatus maps the particular number to a resource block number within the coverage class using a hash function. The resource block number identifies the resource block. The apparatus transmits a device-specific control message to the UE using the determined resource block.

In another aspect of the disclosure, a method, a computer-readable medium, and an apparatus for wireless communication are provided. The apparatus retrieves a particular number. The apparatus determines a resource block for the UE based on the particular number. The apparatus monitors the resource block for a device-specific control message from a base station.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7 is a diagram illustrating an example of downlink common control channel resource.

FIG. 8 is a diagram illustrating an example of using a number transmitted in the channel request to determine a resource block for sending and receiving device-specific control message.

FIG. 9 is a flowchart of a method of wireless communication.

FIG. 10 is a flowchart of a method of wireless communication.

FIG. 11A is a diagram illustrating an example of monitoring a neighboring resource block that is immediately before or immediately after the determined resource block in time for the device-specific control message.

FIG. 11B is a diagram illustrating an example of monitoring one or more reserved resource blocks for the device-specific control message.

FIG. 12 is a conceptual data flow diagram illustrating the data flow between different modules/means/components in an exemplary apparatus.

FIG. 13 is a diagram illustrating an example of a hardware implementation for an apparatus employing a processing system.

FIG. 14 is a conceptual data flow diagram illustrating the data flow between different modules/means/components in an exemplary apparatus.

FIG. 15 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

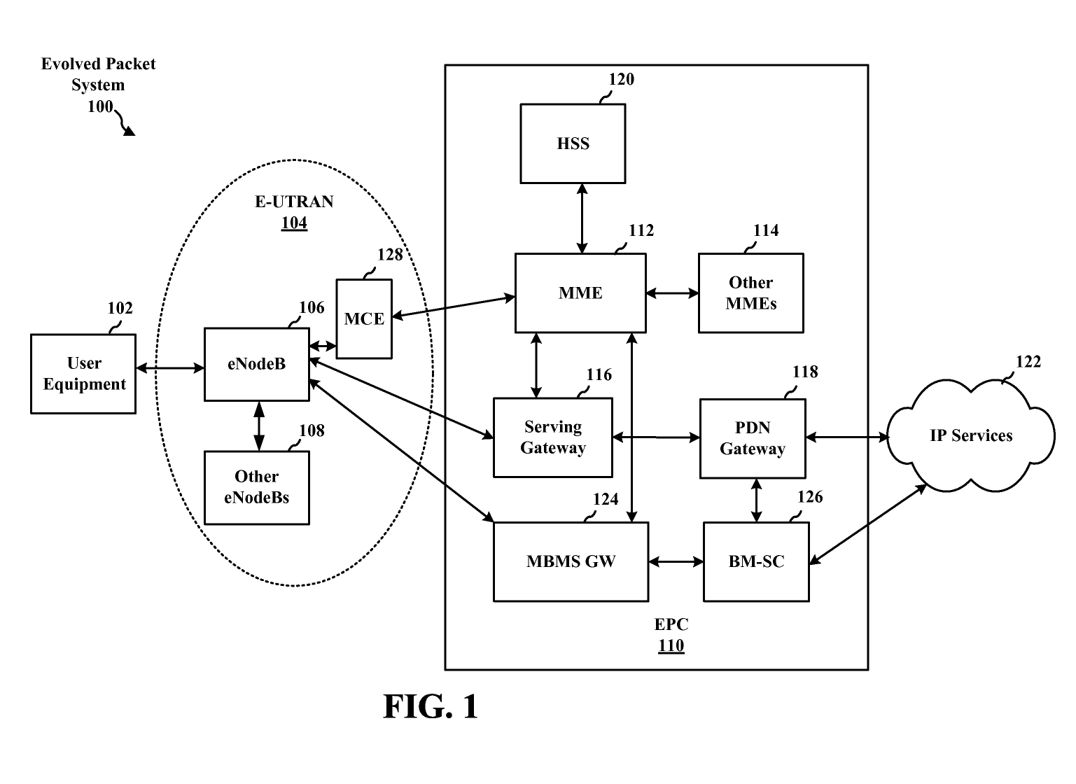

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108, and may include a Multicast Coordination Entity (MCE) 128. The eNB 106 provides user and control planes protocol terminations toward the UE 102. The eNB 106 may be connected to the other eNBs 108 via a backhaul (e.g., an X2 interface). The MCE 128 allocates time/frequency radio resources for evolved Multimedia Broadcast Multicast Service (MBMS) (eMBMS), and determines the radio configuration (e.g., a modulation and coding scheme (MCS)) for the eMBMS. The MCE 128 may be a separate entity or part of the eNB 106. The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 may include a Mobility Management Entity (MME) 112, a Home Subscriber Server (HSS) 120, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 and the BM-SC 126 are connected to the IP Services 122. The IP Services 122 may include the Internet, an intranet, an IP Multimedia Subsystem (IMS), a PS Streaming Service (PSS), and/or other IP services. The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

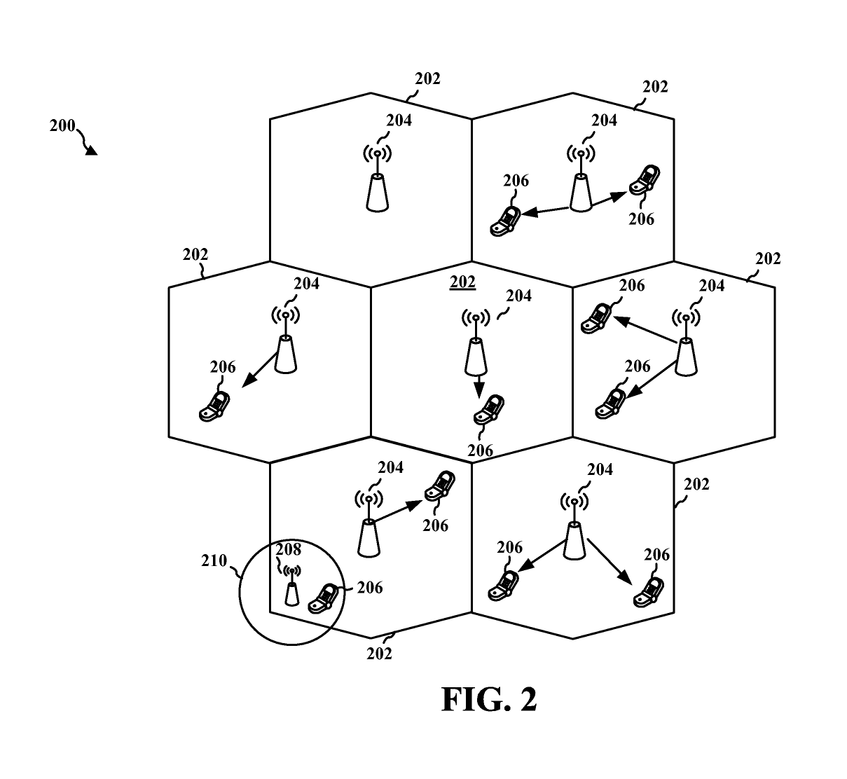

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB may support one or multiple (e.g., three) cells (also referred to as a sectors). The term “cell” can refer to the smallest coverage area of an eNB and/or an eNB subsystem serving a particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

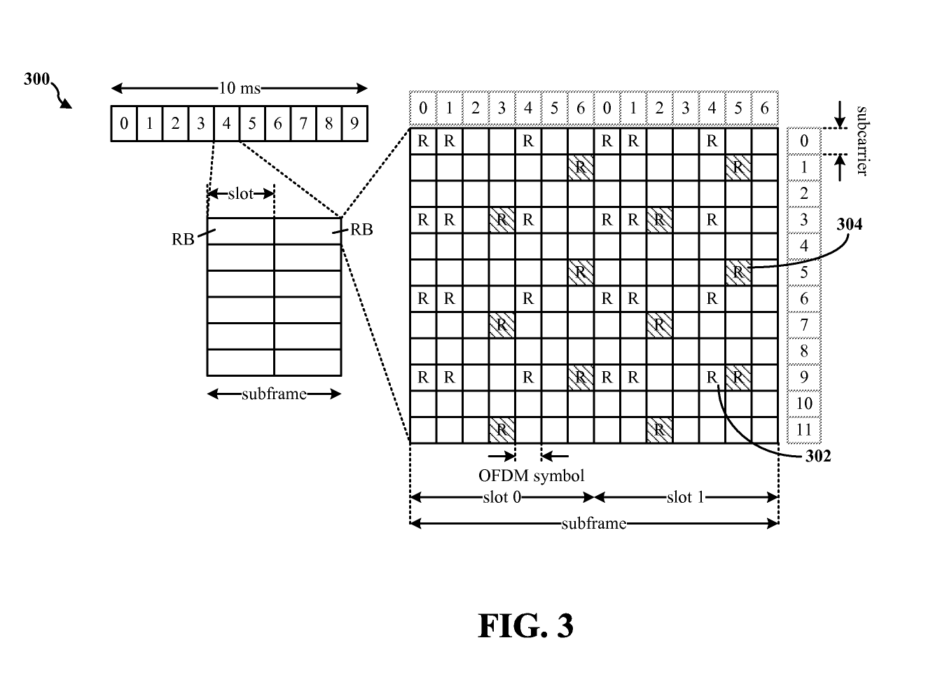

FIG. 3 is a diagram 300 illustrating an example of a DL frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, for a normal cyclic prefix, a resource block contains 12 consecutive subcarriers in the frequency domain and 7 consecutive OFDM symbols in the time domain, for a total of 84 resource elements. For an extended cyclic prefix, a resource block contains 12 consecutive subcarriers in the frequency domain and 6 consecutive OFDM symbols in the time domain, for a total of 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

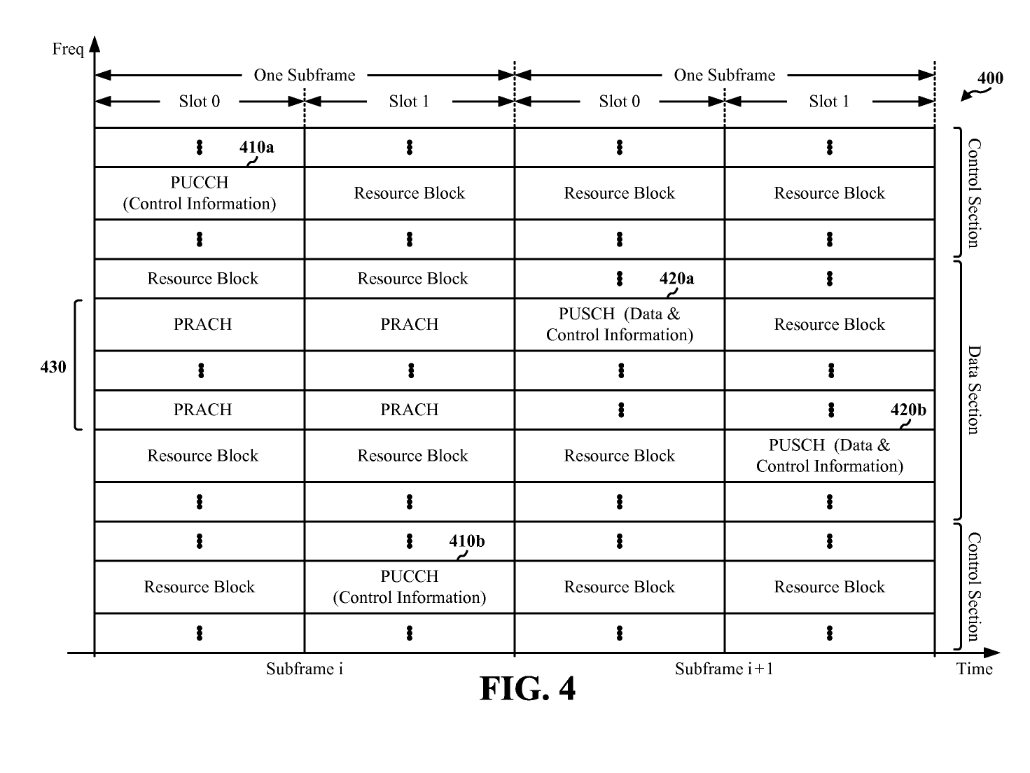

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make a single PRACH attempt per frame (10 ms).

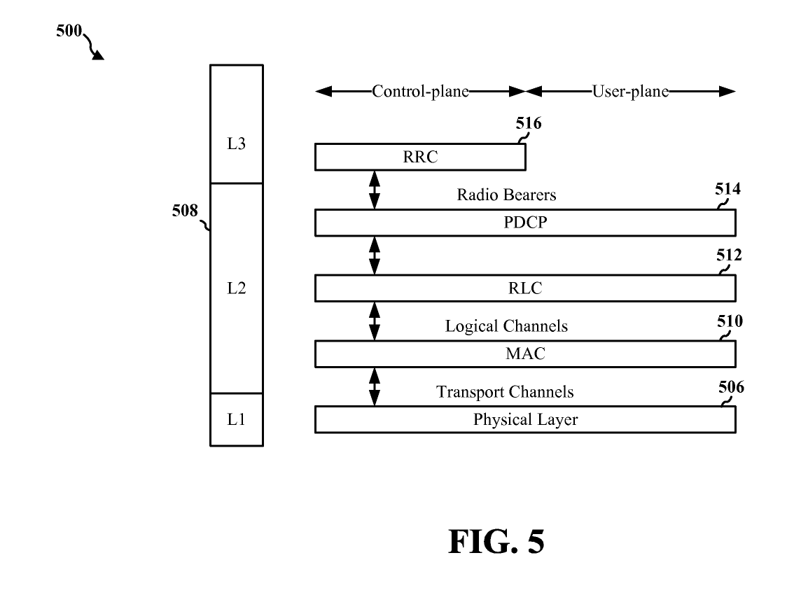

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (e.g., radio bearers) and for configuring the lower layers using RRC signaling between the eNB and the UE.

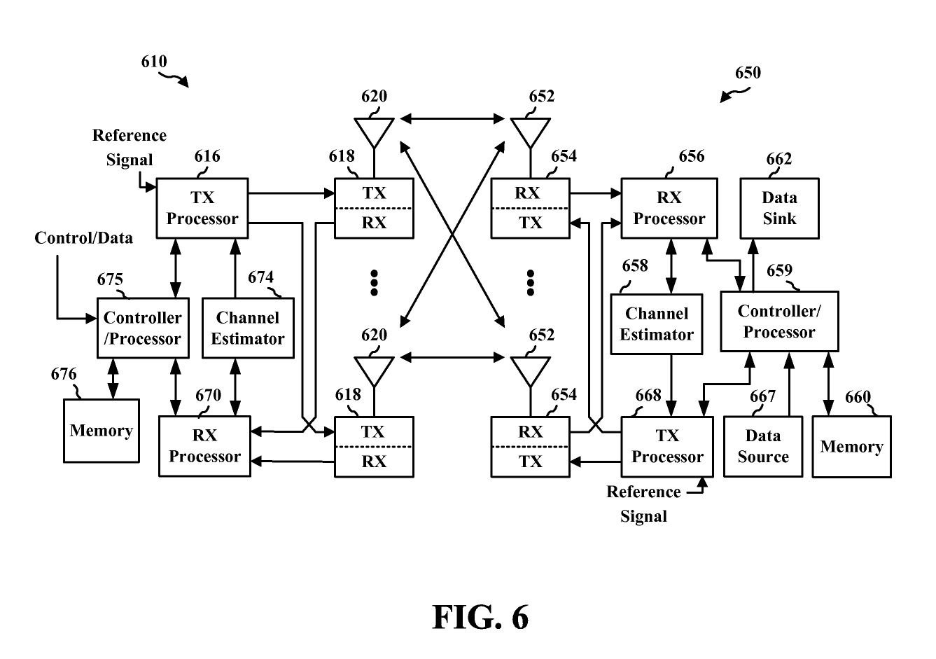

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter 618TX. Each transmitter 618TX may modulate an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 may perform spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 may be provided to different antenna 652 via separate transmitters 654TX. Each transmitter 654TX may modulate an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the controller/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

The Internet of Things (IoT) is the network of devices embedded with electronics, software, sensors and connectivity to enable it to achieve greater value and service by exchanging data with the manufacturer, operator and/or other connected devices. Each device is uniquely identifiable through its embedded computing system but is able to interoperate within the existing Internet infrastructure. IoT device may be connected with personal area network (PAN) or local area network (LAN) or Wi-Fi (wireless LAN) or cellular network. In one configuration, a narrowband OFDMA is used for cellular IoT together with high level MAC procedures for data transfer. In one configuration, physical layer has a downlink common control channel (e.g., Physical Downlink Control Channel (PDCCH)) utilizing one or more timeslots and one or more frequency sub-carriers. Like many other cellular systems such as LTE, the PDCCH carries control messages designated to different mobile devices (i.e., device-specific control messages). For example, a device-specific control message for mobile device A is designated to and addressed to the mobile device A; and a device-specific control message for mobile device B is designated to and addressed to the mobile device B.

In one configuration, the downlink common control channel is further sub-divided according to the channel coupling loss (similar to path loss but includes antenna gains) and each sub group is further sub-divided into multiple resource blocks so that each resource block can carry a control message for different mobile devices. By doing this, system resource (time and frequency bandwidth) can be saved by assigning different amount of resources based on channel coupling loss. In addition, a mobile device will not need to read all the messages in order to retrieve the control message specifically designated for the mobile device.

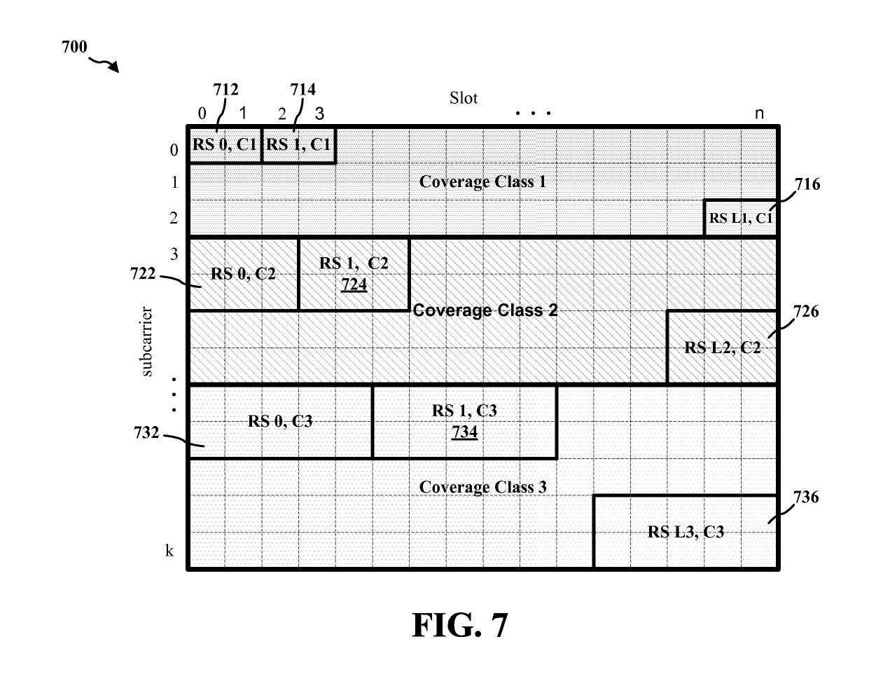

FIG. 7 is a diagram 700 illustrating an example of downlink common control channel resource. The downlink common control channel may consist of n+1 time slots (e.g., time slots 0−n) and k+1 subcarriers (e.g., subcarriers 0−k). This two dimensional slot and subcarrier downlink common control channel is split into two or more coverage classes, e.g., coverage class 1, coverage class 2 and coverage class 3, etc. In one configuration, coverage class 1 corresponds to the strongest signal level seen by the mobile device while coverage class 3 corresponds to the weakest signal level seen by the mobile device. In one configuration, the term signal level could mean power level, signal quality such as signal-to-noise ratio, combination of both or some other metrics.

Because coverage class 1 corresponds to the strongest signal level seen by the mobile device, less resource may be used for error correction, redundancy, etc. Thus each mobile device in coverage class 1 may be assigned less resource for its control message. For example and in one configuration, a mobile device in coverage class 1 may be assigned a resource block 712, 714, or 716, each of which contain two resource elements (e.g., two time slots at a single subcarrier). Because the downlink signal strength is weaker for mobile devices in coverage class 2, each mobile device in coverage class 2 may be assigned more resource for its control message than a mobile device in coverage class 1. For example and in one configuration, a mobile device in coverage class 2 may be assigned a resource block 722, 724, or 726, each of which contain six resource elements (e.g., three time slots over two subcarriers). Similarly, because coverage class 3 corresponds to the weakest signal level seen by the mobile device, each mobile device in coverage class 3 may be assigned the most resource for its control message. For example and in one configuration, a mobile device in coverage class 3 may be assigned a resource block 732, 734, or 736, each of which contain 10 resource elements (e.g., five time slots over two subcarriers).

The channel coupling loss or other metrics used in determining downlink common control channel coverage class can be derived by means of monitoring downlink synchronization signals and broadcasting signals. In one configuration, the measuring results are then feed back to the base station, e.g., in uplink random access signal. Other means for sending the measuring results are also possible. For instance and in one configuration, in NB-OFDMA, the random access channel also has a similar separation of subcarriers/slots into different coverage classes. So that the mobile station experiencing different downlink signal levels can use different coverage classes to send channel request. A base station may obtain the coverage class information of a mobile device by looking at the coverage class used by the mobile device to send channel request.

After determining or measuring the coupling loss (or path loss) of the downlink signal, a mobile station may map this measurement to one of the coverage class according to defined rules. When the mobile station needs to access the communication system, the mobile station may send a channel request in one of the PRACH resource blocks. For each coverage class, there can be more than one PRACH resource blocks available for the mobile station to use. To minimize the chances of two mobile stations belonging to the same coverage class send a PRACH in the same PRACH resource block at the same time and corrupting each other's transmission, each mobile station randomly selects one PRACH resource block from the available resource blocks for the corresponding coverage class. In one configuration, the contents of the PRACH, amongst other things, contains a random number. When the network sends a control message on the downlink common control channel (e.g., PDCCH) to this mobile station it includes the random number in the control message so that mobile station can detect which control message on the downlink common control channel is intended to itself. In one configuration, the random number could be a subset of the mobile identity.

After the mobile station has sent the channel request in the PRACH, it then monitors the downlink common control channel (e.g., PDCCH to receive control messages addressed to this mobile station, in particular a control message that is in response to the channel request in the PRACH. As can be seen from FIG. 7, for a given coverage class there can be many downlink resource blocks that could carry a control message for this mobile station. This means the mobile station will need to receive and process messages carried in each of these downlink resource blocks until the mobile station finds a control message that is addressed to itself. This leads to a lot of processing requirements, hence wasting energy in the mobile device. These mobile devices could be machine-type communications (MTC) type of devices operating on low capacity, non-rechargeable battery. Therefore, to minimize processing load, it is desirable for a given device to monitor and decode only a subset (or even one) of the resource blocks corresponding to its coverage class.

In one configuration, the network (e.g., a base station) uses a number received in the channel request to determine which resource block to be used to send the response to the mobile station. The number may be a random number generated by the mobile station, or any unique identifier (ID) of the mobile station as long as it is known by both the base station and the mobile station at the time of sending the device-specific control message. Similarly, mobile stations also use the same algorithm to determine which resource block it should monitor and decode to receive the response from the network.

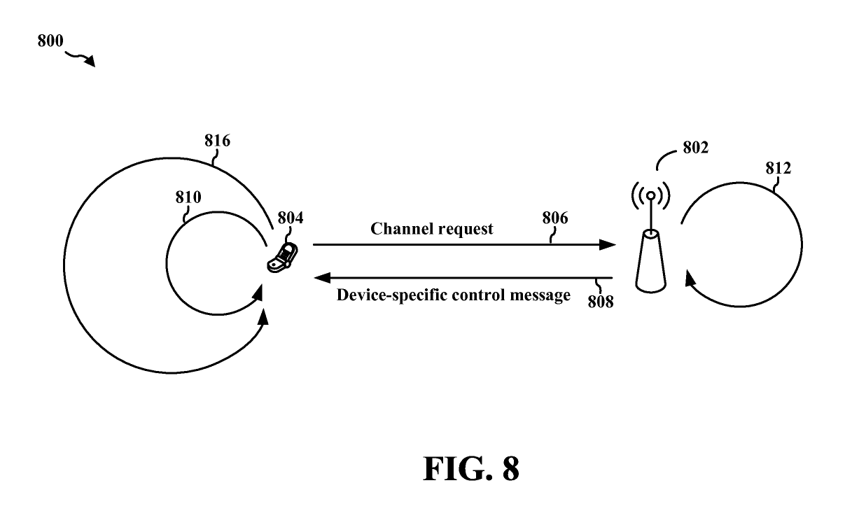

FIG. 8 is a diagram 800 illustrating an example of using a number transmitted in the channel request to determine a resource block for sending and receiving device-specific control message. As illustrated, a UE 804 retrieves (at 810) a particular number for transmitting in a channel request. The particular number may be a random number generated by the UE 804, or a unique ID of the UE 804.

The UE 804 sends the channel request 806 to a base station 802. Based on the particular number contained within the channel request 806, the base station 802 determines (at 812) a resource block on the downlink common control channel for transmitting a device-specific control message back to the UE 804. The base station 802 then transmits the device-specific control message 808 to the UE 804 using the determined resource block.

The UE 804 determines (at 816) a resource block on the downlink common control channel for itself using the same algorithm used by the base station 802 in determining the resource block at 812. The UE 804 then monitors the determined resource block on the downlink common control channel for the device-specific control message 808 addressed to the UE 804. This saves the processing complexity of the UE 804 by i) independently encoding each control message and ii) reducing the number of control messages the UE 804 needs to read by designating a resource block for the control message addressed to the UE 804.

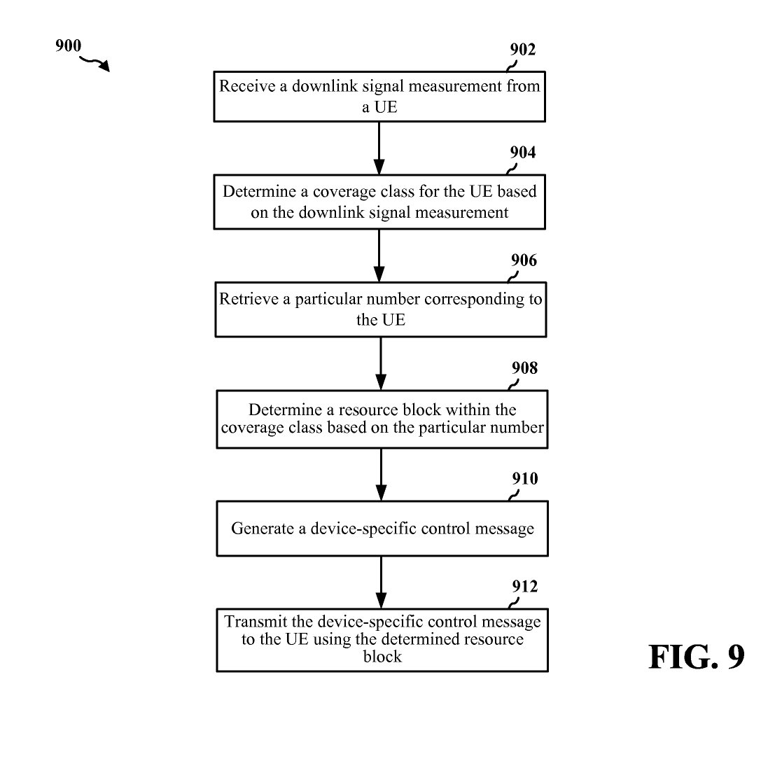

FIG. 9 is a flowchart 900 of a method of wireless communication. The method may be performed by an eNB (e.g., the eNB 106, 204, 610, the apparatus 1202/1202′). At 902, the eNB receives a downlink signal measurement from a UE. In one configuration, the downlink signal measurement may be the downlink channel coupling loss or path loss that can be derived by means of monitoring downlink synchronization signals and broadcasting signals at the UE.

At 904, the eNB determines a coverage class on the downlink common control channel for the UE based on the downlink signal measurement received from the UE. For example and in one configuration, if the downlink signal measurement received from the UE indicates the strongest signal level, the eNB determines coverage class 1 for the UE. If the downlink signal measurement received from the UE indicates the weakest signal level, the eNB determines coverage class 3 for the UE. In one configuration, instead of using downlink signal measurement received from the UE, the eNB determines the coverage class by retrieving a previously stored coverage class for the UE. In such configuration, if no previously stored coverage class for the UE is retrieved or the UE is mobile, the eNB determines the coverage class as the worst case coverage class (e.g., coverage class 3).

At 906, the eNB may retrieve a particular number corresponding to the UE. In one configuration, the eNB may receive a channel request from the UE, and the channel request may include the particular number. The particular number may be a random number generated by the UE, or a unique ID of the UE. In an alternative configuration, instead of receiving the particular number from the UE, the eNB may assign the particular number itself. In such configuration, the eNB may inform the UE about the particular number through a control channel. For example, after the UE sends a random access signal to the eNB for the first time, the eNB may respond with an access grant, which may convey the particular number assigned to the UE by the eNB.

At 908, the eNB may determine a resource block within the coverage class based on the particular number. In one configuration, the eNB maps the particular number to a resource block number within the coverage class using a hash function. The resource block number identifies a resource block that may be used for transmitting control message addressed to the UE. In one configuration, the hash function defines the resource block number as a remainder of a division of the particular number by a number of resource blocks available for the coverage class. For example, the following equation can be used by both the UE and the eNB to identify the downlink common control channel (e.g., PDCCH) resource block.

RB=PARTICULAR_NUM mod Num_RBs (1)

where
RB is resource block number, 0 to n (n in this case is Num_RBs−1),
PARTICULAR_NUM is the particular number sent in the channel request or assigned by the eNB,
Num_RBs is the number of resource blocks available for the given coverage class, and
mod represents mathematical modulo operation.

In one configuration, the eNB may determine several resource blocks within the coverage class based on the particular number. For example, in addition to the resource block determined above at 908, the eNB may also include the neighboring resource blocks of the determined resource block (e.g., resources blocks immediately before or after the determined resource block in time) as potential resource blocks for transmitting control message addressed to the UE. In such configuration, the eNB may select one resource block from the determined several resource blocks for transmitting control message addressed to the UE.

At 910, the eNB generates a device-specific control message addressed to the UE. In one configuration, the device-specific control message may contain the particular number. In such configuration, the eNB generates the device-specific control message by including the particular number in the device-specific control message.

At 912, the eNB transmits the device-specific control message to the UE using the determined resource block.

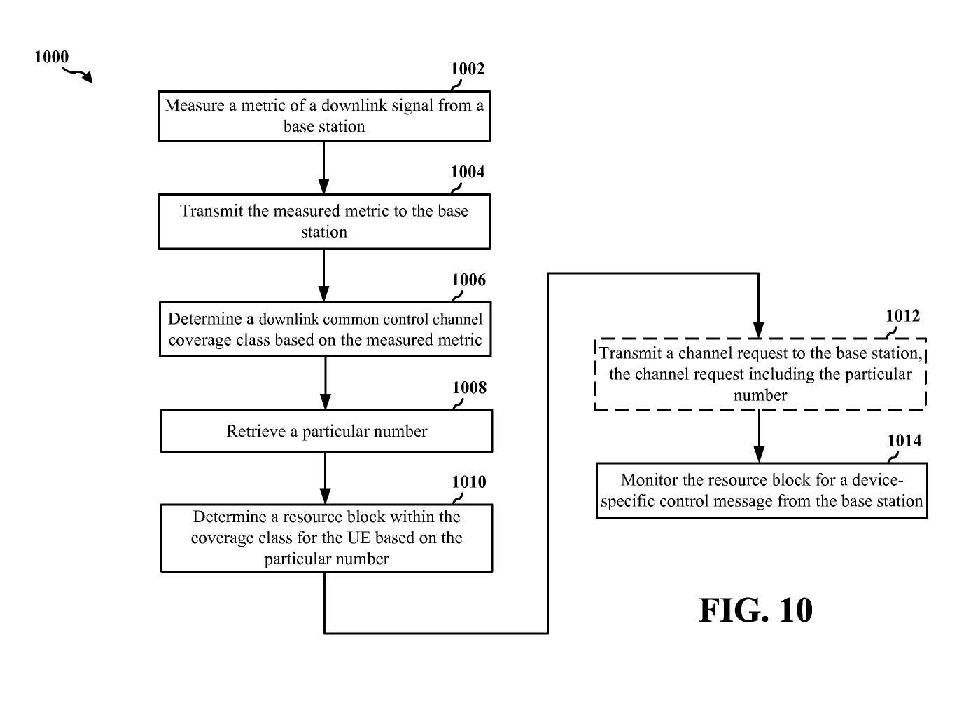

FIG. 10 is a flowchart 1000 of a method of wireless communication. The method may be performed by a UE (e.g., the UE 102, 206, 650, the apparatus 1402/1402′). At 1002, the UE measures a metric of a downlink signal from a base station. In one configuration, the metric may be the downlink channel coupling loss or path loss that can be derived by means of monitoring downlink synchronization signals and broadcasting signals. In one configuration, the metric may be measured by using a signal measuring circuit.

At 1004, the UE transmits the measured metric to the base station. At 1006, the UE determines a downlink common control channel coverage class for the UE based on the measured metric. For example and in one configuration, if the measured metric indicates the strongest signal level, coverage class 1 may be determined for the UE. If the measured metric indicates the weakest signal level, coverage class 3 may be determined for the UE.

At 1008, the UE may retrieve a particular number. In one configuration, the particular number may be a random number generated by the UE, or a unique ID of the UE. In another configuration, the base station may assign the particular number to the UE and inform the UE about the particular number through a control channel.

At 1010, the UE determines a resource block within the coverage class for the UE based on the particular number using the same algorithm used by the base station in determining the resource block, as describe above with reference to 908 of FIG. 9. In one configuration, the UE may determine several resource blocks within the coverage class based on the particular number. For example, in addition to the resource block determined above, the UE may also include the neighboring resource blocks of the determined resource block (e.g., resources blocks immediately before or after the determined resource block in time) as potential resource blocks for receiving control message addressed to the UE.

At 1012, the UE optionally transmits a channel request to the base station. The channel request may contain the particular number so that the base station may be able to use the particular number to determine resource block for transmitting device-specific control message to the UE.

At 1014, the UE monitors the determined resource block for a device-specific control message addressed to the UE from the base station. In one configuration, the UE may check the contents of the determined resource block of each frame or subframe to determine if a device-specific control message addressed to the UE is carried on that resource block. In one configuration, instead of determining a single resource block and monitoring the single resource block, the UE may determine several resource blocks and monitor the determined several resource blocks for a device-specific control message addressed to the UE from the base station.

With the methods described above in FIGS. 9 and 10, it is possible that more than one mobile station may end up reading the same resource block, but each resource block has capacity to carry message for just one mobile station. However, as the control message contained in the resource block will have mobile station's particular number to identify it, the other mobile station will ignore the control message and continue to monitor the resource block on the next downlink common control channel subframe.

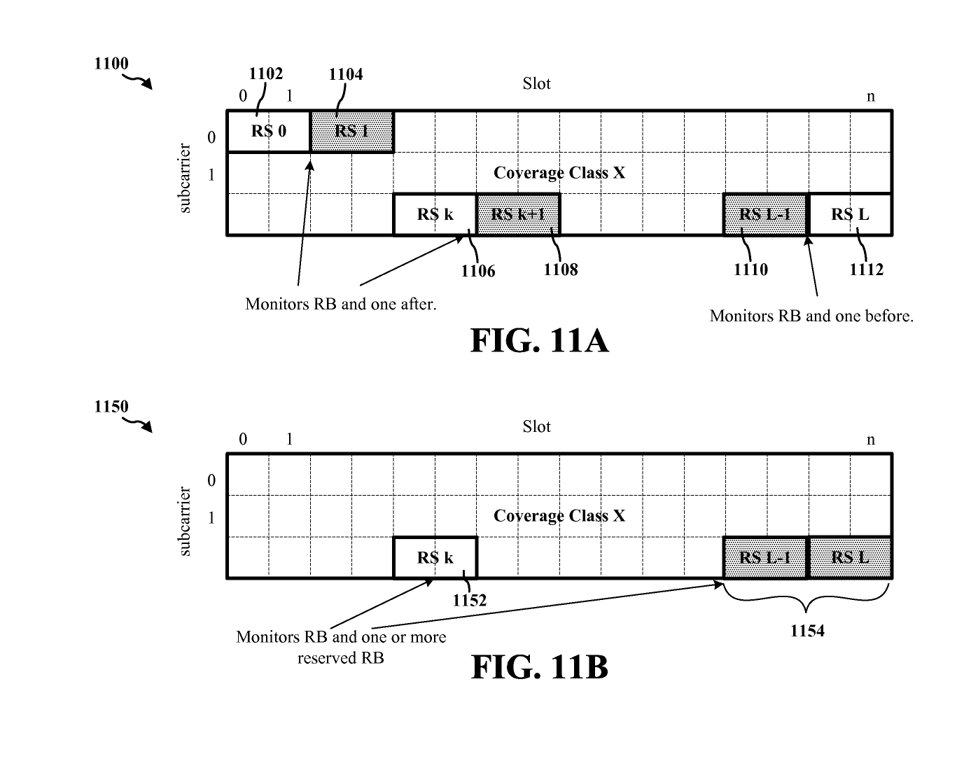

In one configuration, if the resource block determined at 908 of FIG. 9 is used by another UE, the eNB may transmit the device-specific control message to the UE using a neighboring resource block that is immediately before or immediately after the resource block in time. Accordingly, the UE may, in addition to monitoring the resource block determined at 1010 of FIG. 10, monitor a neighboring resource block that is immediately before or immediately after the resource block in time for the device-specific control message, as illustrated in FIG. 11A.

In such configuration, the UE at worst will need to decode up to two resource blocks per downlink common control channel subframe. If the UE still does not receive control message addressed to the UE, the UE continues to the next downlink common control channel subframe and follows the same process.

FIG. 11A is a diagram 1100 illustrating an example of monitoring a neighboring resource block that is immediately before or immediately after the determined resource block in time for the device-specific control message. As shown in the example, in addition to monitoring the determined resource block 1102, the UE may monitor a neighboring resource block 1104 that is immediately after the resource block 1102 in time for the device-specific control message. Similarly, in addition to monitoring the determined resource block 1106, the UE may monitor a neighboring resource block 1108 that is immediately after the resource block 1106 in time for the device-specific control message. In one configuration, in addition to monitoring the determined resource block 1112, the UE may monitor a neighboring resource block 1110 that is immediately before the resource block 1112 in time for the device-specific control message.

In one configuration, one or more resource blocks in a coverage class may be reserved. If the resource block determined at 908 of FIG. 9 is used by another UE, the eNB transmits the device-specific control message to the UE using one of the reserved resource blocks. Accordingly, the UE may, in addition to monitoring the resource block determined at 1010 of FIG. 10, monitor one or more reserved resource blocks for the device-specific control message, as illustrated in FIG. 11B.

For instance and in one configuration, a coverage class may have Num_RB+k (k represents the number of reserved resource blocks) resource blocks but the resource block a message will use is still determined by Equation (1). In case two or more messages ends up with the same resource block RB according to Equation (1), the control message associated with the smallest PARTICULAR_NUM is sent over resource block RB. For instance, if k=2, messages associated with larger PARTICULAR_NUM are sent over resource block NUM_RB, NUM_RB+1, in an ascending order of PARTICULAR_NUM. By doing this, the UE will at most read two or three control messages in each subframe.

FIG. 11B is a diagram 1150 illustrating an example of monitoring one or more reserved resource blocks for the device-specific control message. As shown in the example, in addition to monitoring the determined resource block 1152, the UE may monitor two reserved resource blocks 1154 for the device-specific control message addressed to the UE.

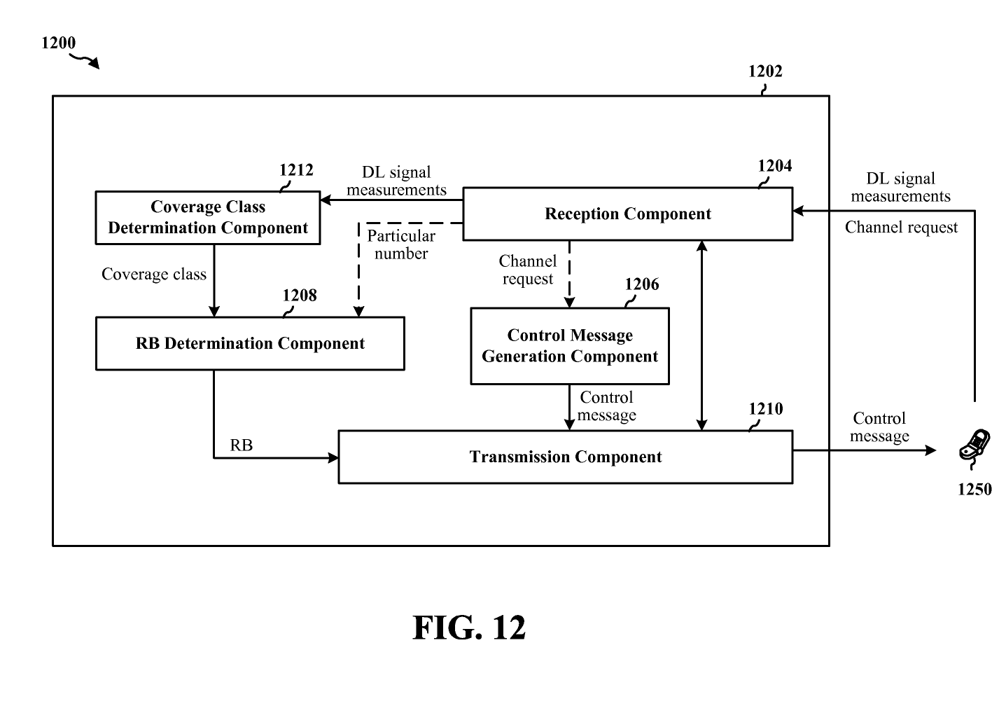

FIG. 12 is a conceptual data flow diagram 1200 illustrating the data flow between different modules/means/components in an exemplary apparatus 1202. The apparatus 1202 may be an eNB. The apparatus 1202 may include a reception component 1204 that is configured to receive downlink signal measurements and/or channel request from a UE 1250. The channel request may contain a particular number for the UE 1250. In one configuration, the reception component 1204 performs the operations described above with reference to 902 and/or 906 of FIG. 9. The apparatus 1202 may include a transmission component 1210 that is configured to transmit device-specific control message to the UE 1250. The transmission component 1210 may be configured to receive a control message and a determined resource block for carrying the control message, and to transmit the control message to the UE 1250 using the determined resource block. In one configuration, the transmission component 1210 performs the operations described above with reference to 912 of FIG. 9. The reception component 1204 and the transmission component 1210 may communicate with each other to coordinate the communication of the apparatus 1202.

The apparatus 1202 may include a coverage class determination component 1212 that is configured to determine a downlink common control channel coverage class for the UE 1250. The coverage class determination component 1212 may receive downlink signal measurements from the reception component 1204 and determine the downlink common control channel coverage class based on the downlink signal measurements. In one configuration, the coverage class determination component 1212 performs the operations described above with reference to 904 of FIG. 9.

The apparatus 1202 may include a resource block determination component 1208 that is configured to determine a resource block within a coverage class for the UE 1250 based on a particular number. The resource block determination component 1208 may receive the coverage class for the UE 1250 from the coverage class determination component 1212. The resource block determination component 1208 may be optionally configured to receive the particular number for the UE 1250 from the reception component 1204. In an alternative configuration, the resource block determination component 1208 may be configured to assign a particular number to the UE 1250. In one configuration, the resource block determination component 1208 performs the operations described above with reference to 908 of FIG. 9.

The apparatus 1202 may include a control message generation component 1206 that is configured to generate a device-specific control message for the UE 1250. In one configuration, the control message generation component 1206 may optionally receive a channel request from the reception component 1204, and generate the control message in response to the channel request. In one configuration, the control message generation component 1206 performs the operations described above with reference to 910 of FIG. 9.

The apparatus may include additional components that perform each of the blocks of the algorithm in the aforementioned flowcharts of FIG. 9. As such, each block in the aforementioned flowcharts of FIG. 9 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

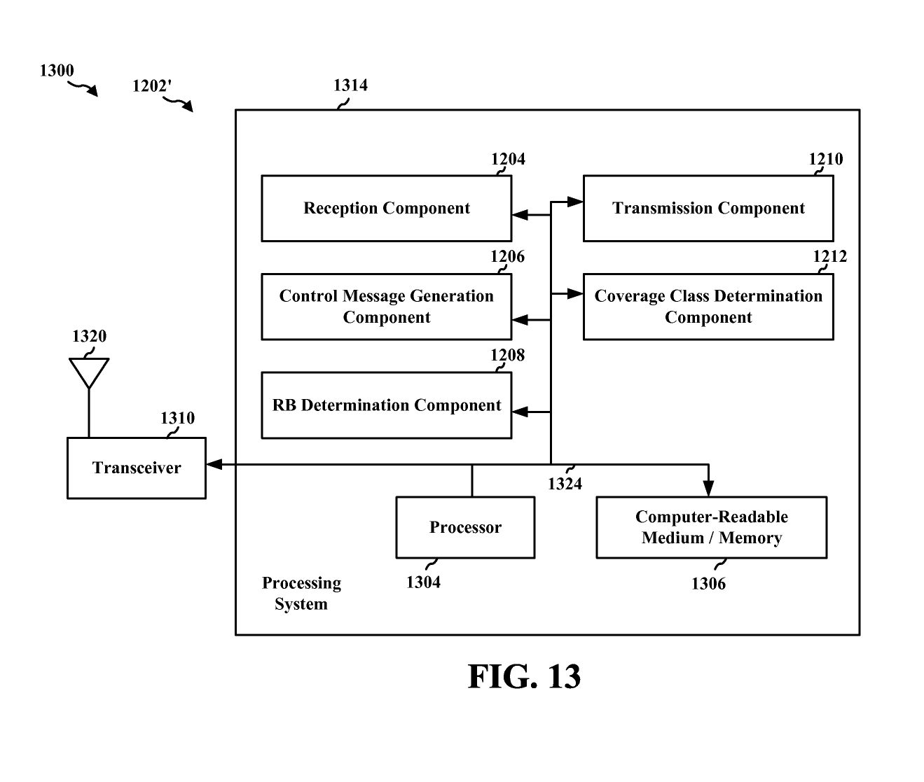

FIG. 13 is a diagram 1300 illustrating an example of a hardware implementation for an apparatus 1202′ employing a processing system 1314. The processing system 1314 may be implemented with a bus architecture, represented generally by the bus 1324. The bus 1324 may include any number of interconnecting buses and bridges depending on the specific application of the processing system 1314 and the overall design constraints. The bus 1324 links together various circuits including one or more processors and/or hardware components, represented by the processor 1304, the components 1204, 1206, 1208, 1210, 1212 and the computer-readable medium/memory 1306. The bus 1324 may also link various other circuits such as timing sources, peripherals, voltage regulators, and power management circuits, which are well known in the art, and therefore, will not be described any further.

The processing system 1314 may be coupled to a transceiver 1310. The transceiver 1310 is coupled to one or more antennas 1320. The transceiver 1310 provides a means for communicating with various other apparatus over a transmission medium. The transceiver 1310 receives a signal from the one or more antennas 1320, extracts information from the received signal, and provides the extracted information to the processing system 1314, specifically the reception component 1204. In addition, the transceiver 1310 receives information from the processing system 1314, specifically the transmission component 1210, and based on the received information, generates a signal to be applied to the one or more antennas 1320. The processing system 1314 includes a processor 1304 coupled to a computer-readable medium/memory 1306. The processor 1304 is responsible for general processing, including the execution of software stored on the computer-readable medium/memory 1306. The software, when executed by the processor 1304, causes the processing system 1314 to perform the various functions described supra for any particular apparatus. The computer-readable medium/memory 1306 may also be used for storing data that is manipulated by the processor 1304 when executing software. The processing system further includes at least one of the components 1204, 1206, 1208, 1210, and 1212. The components may be software components running in the processor 1304, resident/stored in the computer readable medium/memory 1306, one or more hardware components coupled to the processor 1304, or some combination thereof. The processing system 1314 may be a component of the eNB 610 and may include the memory 676 and/or at least one of the TX processor 616, the RX processor 670, and the controller/processor 675.

In one configuration, the apparatus 1202/1202′ for wireless communication includes means for receiving a downlink signal measurement from a UE. The means for receiving a downlink signal measurement may be the transceiver 1310, the one or more antennas 1320, the reception component 1204, or the processor 1304. In one configuration, the means for receiving a downlink signal measurement performs the operations described above with reference to 902 of FIG. 9.

In one configuration, the apparatus 1202/1202′ includes means for determining a coverage class for the UE based on the downlink signal measurement. The means for determining a coverage class may be the coverage class determination component 1212 or the processor 1304. In one configuration, the means for determining a coverage class performs the operations described above with reference to 904 of FIG. 9.

In one configuration, the apparatus 1202/1202′ includes means for retrieving a particular number corresponding to the UE. The means for retrieving a particular number may be the transceiver 1310, the one or more antennas 1320, the reception component 1204, the resource block determination component 1208, or the processor 1304. In one configuration, the means for retrieving the particular number is configured to receive a channel request from the UE, and the channel request includes the particular number. In another configuration, the means for retrieving the particular number is configured to assign the particular number to the UE. In one configuration, the means for retrieving a particular number performs the operations described above with reference to 906 of FIG. 9.

In one configuration, the apparatus 1202/1202′ includes means for determining a resource block class based on the particular number. In one configuration, the means for determining the resource block may be configured to determine the resource block within a coverage class. In one configuration, the means for determining the resource block may be configured to map the particular number to a resource block number within the coverage class using a hash function, and the resource block number identifies the resource block. The means for determining a resource block may be the resource block determination component 1208 or the processor 1304. In one configuration, the means for determining a resource block performs the operations described above with reference to 908 of FIG. 9.

In one configuration, the means for determining the resource block based on the particular number may be configured to determine a plurality of resource blocks based on the particular number. In such configuration, the apparatus 1202/1202′ may further include means for selecting one resource block from the plurality of resource blocks. The means for transmitting the device-specific control message may be configured to transmit the device-specific control message to the UE using the one resource block.

In one configuration, the apparatus 1202/1202′ includes means for generating a device-specific control message. The means for generating a device-specific control message may be the control message generation component 1206 or the processor 1304. In one configuration, the means for generating a device-specific control message performs the operations described above with reference to 910 of FIG. 9.

In one configuration, the apparatus 1202/1202′ includes means for transmitting the device-specific control message to the UE using the resource block. The means for transmitting the device-specific control message may be the transceiver 1310, the one or more antennas 1320, the transmission component 1210, or the processor 1304. In one configuration, the means for transmitting the device-specific control message performs the operations described above with reference to 912 of FIG. 9.

In one configuration, the apparatus 1202/1202′ may include means for retrieving the coverage class for the UE. In one configuration, the means for retrieving the coverage class may be configured to retrieve the coverage class for the UE by searching and retrieving a previously stored coverage class for the UE. In one configuration, the apparatus 1202/1202′ may include means for determining the coverage class as a worst case coverage class in response to no previous record of coverage class for the UE or the UE being mobile.

In one configuration, the apparatus 1202/1202′ may include means for transmitting, in response to the resource block being used by another UE, the device-specific control message to the UE using a neighboring resource block that is immediately before or immediately after the resource block in time. In one configuration, the apparatus 1202/1202′ may include means for transmitting, in response to the resource block being used by another UE, the device-specific control message to the UE using a reserved resource block.

The aforementioned means may be one or more of the aforementioned components of the apparatus 1202 and/or the processing system 1314 of the apparatus 1202′ configured to perform the functions recited by the aforementioned means. As described supra, the processing system 1314 may include the TX Processor 616, the RX Processor 670, and the controller/processor 675. As such, in one configuration, the aforementioned means may be the TX Processor 616, the RX Processor 670, and the controller/processor 675 configured to perform the functions recited by the aforementioned means.

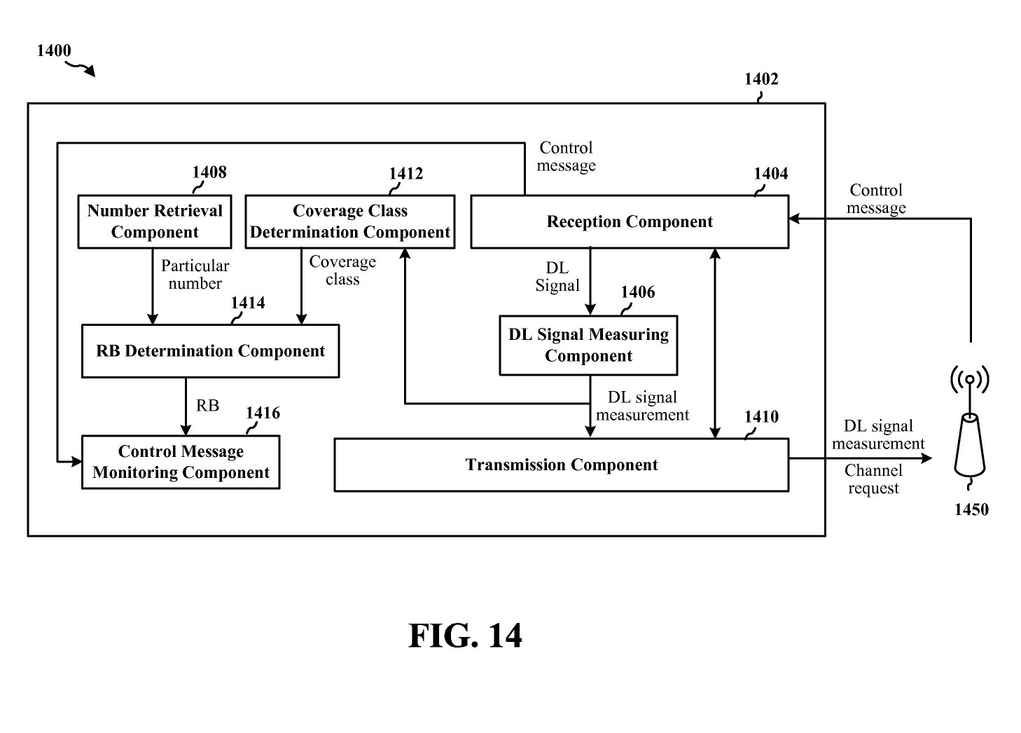

FIG. 14 is a conceptual data flow diagram 1400 illustrating the data flow between different modules/means/components in an exemplary apparatus 1402. The apparatus may be a UE. The apparatus 1402 includes a reception component 1404 that is configured to receive control messages from an eNB 1450. The apparatus 1402 includes a transmission component 1410 that is configured to transmit downlink signal measurements and/or channel request to the eNB 1450. The transmission component 1410 may be configured to receive downlink signal measurements from a downlink signal measuring component 1406 and/or to receive a channel request from another component (not shown) of the apparatus 1402. In one configuration, the transmission component 1210 performs the operations described above with reference to 1004 and 1012 of FIG. 10. The reception component 1404 and the transmission component 1410 may communicate with each other to coordinate the communication of the apparatus 1402.

The apparatus 1402 includes the downlink signal measuring component 1406 that is configured to measure a metric of a downlink signal from the eNB 1450. The downlink signal measuring component 1406 may receive downlink signal from the reception component 1404 and measures the metric of the downlink signal. In one configuration, the downlink signal measuring component 1406 performs the operations described above with reference to 1002 of FIG. 10.

The apparatus 1402 may include a coverage class determination component 1412 that is configured to determine a downlink common control channel coverage class for the apparatus 1402. The coverage class determination component 1412 may receive downlink signal measurements from the downlink signal measuring component 1406 and determine the downlink common control channel coverage class based on the downlink signal measurements. In one configuration, the coverage class determination component 1412 performs the operations described above with reference to 1006 of FIG. 10.

The apparatus 1402 includes a number retrieval component 1408 that is configured to retrieve a particular number for the apparatus 1402. In one configuration, the number retrieval component 1408 performs the operations described above with reference to 1008 of FIG. 10.

The apparatus 1402 may include a resource block determination component 1414 that is configured to determine a resource block within a coverage class for the apparatus 1402 based on a particular number. The resource block determination component 1414 may receive the coverage class for the apparatus 1402 from the coverage class determination component 1412. The resource block determination component 1414 may be configured to receive the particular number for the apparatus 1402 from the number retrieval component 1408. In one configuration, the resource block determination component 1414 performs the operations described above with reference to 1010 of FIG. 10.

The apparatus 1402 may include a control message monitoring component 1416 that is configured to monitor a device-specific control message for the apparatus 1402. In one configuration, the control message monitoring component 1416 may receive the control message from the reception component 1404. In one configuration, the control message monitoring component 1416 performs the operations described above with reference to 1014 of FIG. 10.

The apparatus may include additional components that perform each of the blocks of the algorithm in the aforementioned flowcharts of FIG. 10. As such, each block in the aforementioned flowcharts of FIG. 10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

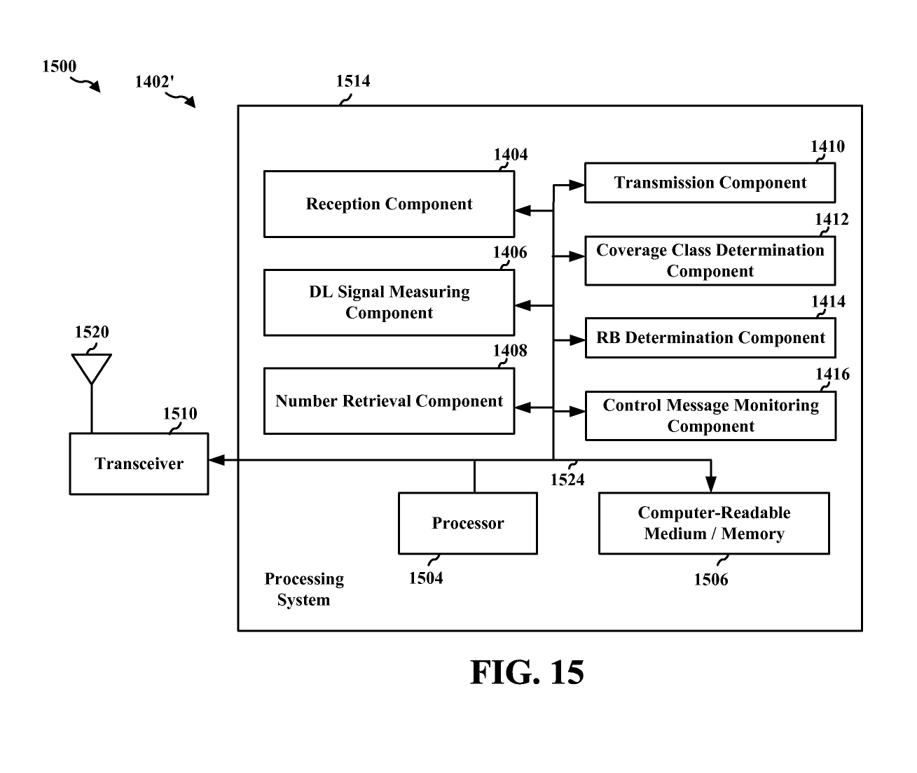

FIG. 15 is a diagram 1500 illustrating an example of a hardware implementation for an apparatus 1402′ employing a processing system 1514. The processing system 1514 may be implemented with a bus architecture, represented generally by the bus 1524. The bus 1524 may include any number of interconnecting buses and bridges depending on the specific application of the processing system 1514 and the overall design constraints. The bus 1524 links together various circuits including one or more processors and/or hardware components, represented by the processor 1504, the components 1404, 1406, 1408, 1410, 1412, 1414, 1416 and the computer-readable medium/memory 1506. The bus 1524 may also link various other circuits such as timing sources, peripherals, voltage regulators, and power management circuits, which are well known in the art, and therefore, will not be described any further.

The processing system 1514 may be coupled to a transceiver 1510. The transceiver 1510 is coupled to one or more antennas 1520. The transceiver 1510 provides a means for communicating with various other apparatus over a transmission medium. The transceiver 1510 receives a signal from the one or more antennas 1520, extracts information from the received signal, and provides the extracted information to the processing system 1514, specifically the reception component 1404. In addition, the transceiver 1510 receives information from the processing system 1514, specifically the transmission component 1410, and based on the received information, generates a signal to be applied to the one or more antennas 1520. The processing system 1514 includes a processor 1504 coupled to a computer-readable medium/memory 1506. The processor 1504 is responsible for general processing, including the execution of software stored on the computer-readable medium/memory 1506. The software, when executed by the processor 1504, causes the processing system 1514 to perform the various functions described supra for any particular apparatus. The computer-readable medium/memory 1506 may also be used for storing data that is manipulated by the processor 1504 when executing software. The processing system further includes at least one of the components 1404, 1406, 1408, 1410, 1412, 1414, and 1416. The components may be software components running in the processor 1504, resident/stored in the computer readable medium/memory 1506, one or more hardware components coupled to the processor 1504, or some combination thereof. The processing system 1514 may be a component of the UE 650 and may include the memory 660 and/or at least one of the TX processor 668, the RX processor 656, and the controller/processor 659.

In one configuration, the apparatus 1402/1402′ for wireless communication includes means for measuring a metric of a downlink signal from a base station. The means for measuring a metric of a downlink signal may be the transceiver 1510, the one or more antennas 1520, the reception component 1404, or the processor 1504. In one configuration, the means for measuring a metric of a downlink signal performs the operations described above with reference to 1002 of FIG. 10.

In one configuration, the apparatus 1402/1402′ may include means for transmitting the measured metric to the base station. The means for transmitting the measured metric may be the transceiver 1510, the one or more antennas 1520, the transmission component 1410, or the processor 1504. In one configuration, the means for transmitting the measured metric performs the operations described above with reference to 1004 of FIG. 10.

In one configuration, the apparatus 1402/1402′ may include means for determining a coverage class based on the measured metric. The means for determining a coverage class may be the coverage class determination component 1412 or the processor 1504. In one configuration, the means for determining a coverage class performs the operations described above with reference to 1006 of FIG. 10. In one configuration, the apparatus 1402/1402′ may include means for determining the coverage class as a worst case coverage class.

In one configuration, the apparatus 1402/1402′ may include means for retrieving a particular number. In one configuration, the means for retrieving the particular number may be configured to generate a random number as the particular number. In one configuration, the means for retrieving the particular number may be configured to use an identifier of the apparatus 1402/1402′ as the particular number. In one configuration, the means for retrieving the particular number may be configured to receive the particular number from the base station. The means for retrieving a particular number may be the number retrieval component 1408 or the processor 1504. In one configuration, the means for retrieving a particular number performs the operations described above with reference to 1008 of FIG. 10.

In one configuration, the apparatus 1402/1402′ may include means for determining a resource block for the apparatus 1402/1402′ based on the particular number. In one configuration, the means for determining the resource block may be configured to determine the resource block within a coverage class. In one configuration, the means for determining the resource block may be further configured to map the particular number to a resource block number within the coverage class using a hash function, and the resource block number identifies the resource block. The means for determining a resource block may be the resource block determination component 1414 or the processor 1504. In one configuration, the means for determining a resource block performs the operations described above with reference to 1010 of FIG. 10.

In one configuration, the means for determining the resource block for the apparatus 1402/1402′ based on the particular number may be configured to determine a plurality of resource blocks based on the particular number. In such configuration, the means for monitoring the resource block may be configured to monitor the plurality of resource blocks for the device-specific control message from the base station.

In one configuration, the apparatus 1402/1402′ may include means for transmitting a channel request to the base station. The means for transmitting a channel request may be the transceiver 1510, the one or more antennas 1520, the transmission component 1410, or the processor 1504. In one configuration, the means for transmitting a channel request performs the operations described above with reference to 1012 of FIG. 10.

In one configuration, the apparatus 1402/1402′ may include means for monitoring the resource block for a device-specific control message from the base station. The means for monitoring the resource block may be the control message monitoring component 1416 or the processor 1504. In one configuration, the means for monitoring the resource block performs the operations described above with reference to 1014 of FIG. 10.

In one configuration, the apparatus 1402/1402′ may include means for monitoring a neighboring resource block that is immediately before or immediately after the resource block in time for the device-specific control message. In one configuration, the apparatus 1402/1402′ may include means for monitoring a reserved resource block for the device-specific control message.

The aforementioned means may be one or more of the aforementioned components of the apparatus 1402 and/or the processing system 1514 of the apparatus 1402′ configured to perform the functions recited by the aforementioned means. As described supra, the processing system 1514 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication, comprising:
retrieving a particular number corresponding to a user equipment (UE);
determining a resource block based on the particular number; and
transmitting a device-specific control message to the UE using the resource block.

2. The method of claim 1, wherein the determining the resource block comprises determining the resource block within a coverage class.

3. The method of claim 2, wherein the retrieving the particular number comprises receiving a channel request from the UE, the channel request comprising the particular number.

4. The method of claim 2, wherein the determining the resource block further comprises mapping the particular number to a resource block number within the coverage class using a hash function, wherein the resource block number identifies the resource block.

5. The method of claim 4, wherein the hash function defines the resource block number as a remainder of a division of the particular number by a number of resource blocks available for the coverage class.

6. The method of claim 1, wherein the retrieving the particular number comprises assigning the particular number to the UE.

7. The method of claim 1 further comprising:
transmitting, in response to the resource block being used by another UE, the device-specific control message to the UE using a neighboring resource block that is immediately before or immediately after the resource block in time.

8. The method of claim 1, wherein the determining the resource block based on the particular number comprises determining a plurality of resource blocks based on the particular number,
the method further comprising selecting one resource block from the plurality of resource blocks,
wherein the transmitting the device-specific control message comprises transmitting the device-specific control message to the UE using the one resource block.

9. The method of claim 1 further comprising:
transmitting, in response to the resource block being used by another UE, the device-specific control message to the UE using a reserved resource block.

10. A method of wireless communication of a user equipment (UE), comprising:
retrieving a particular number;
determining a resource block for the UE based on the particular number; and
monitoring the resource block for a device-specific control message from a base station.

11. The method of claim 10, wherein the retrieving the particular number comprises receiving the particular number from the base station.

12. The method of claim 10, wherein the determining the resource block comprises determining the resource block within a coverage class.

13. The method of claim 12, wherein the determining the resource block further comprises mapping the particular number to a resource block number within the coverage class using a hash function, wherein the resource block number identifies the resource block.

14. The method of claim 10 further comprising:
monitoring a neighboring resource block that is immediately before or immediately after the resource block in time for the device-specific control message.

15. The method of claim 10, wherein the determining the resource block for the UE based on the particular number comprises determining a plurality of resource blocks based on the particular number,
wherein the monitoring the resource block comprises monitoring the plurality of resource blocks for the device-specific control message from the base station.

16. The method of claim 10 further comprising:
monitoring a reserved resource block for the device-specific control message.

17. An apparatus for wireless communication, comprising:
a memory; and
at least one processor coupled to the memory and configured to:
retrieve a particular number corresponding to a user equipment (UE);
determine a resource block based on the particular number; and
transmit a device-specific control message to the UE using the resource block.

18. The apparatus of claim 17, wherein, to determine the resource block, the at least one processor is configured to determine the resource block within a coverage class.

19. The apparatus of claim 18, wherein, to retrieve the particular number, the at least one processor is configured to receive a channel request from the UE, the channel request comprising the particular number.

20. The apparatus of claim 18, wherein, to determine the resource block, the at least one processor is further configured to map the particular number to a resource block number within the coverage class using a hash function, wherein the resource block number identifies the resource block.

21. The apparatus of claim 20, wherein the hash function defines the resource block number as a remainder of a division of the particular number by a number of resource blocks available for the coverage class.

22. The apparatus of claim 17, wherein the at least one processor is further configured to:
transmit, in response to the resource block being used by another UE, the device-specific control message to the UE using a neighboring resource block that is immediately before or immediately after the resource block in time.

23. The apparatus of claim 17, wherein the at least one processor is further configured to:
transmit, in response to the resource block being used by another UE, the device-specific control message to the UE using a reserved resource block.

24. The apparatus of claim 17, wherein, to determine the resource block based on the particular number, the at least one processor is further configured to determine a plurality of resource blocks based on the particular number, and to select one resource block from the plurality of resource blocks,
wherein, to transmit the device-specific control message, the at least one processor is further configured to transmit the device-specific control message to the UE using the one resource block.

25. An apparatus for wireless communication, the apparatus being a user equipment (UE), comprising:
a memory; and
at least one processor coupled to the memory and configured to:
retrieve a particular number;
determine a resource block for the UE based on the particular number; and
monitor the resource block for a device-specific control message from a base station.

26. The apparatus of claim 25, wherein, to determine the resource block, the at least one processor is configured to determine the resource block within a coverage class.

27. The apparatus of claim 26, wherein, to determine the resource block, the at least one processor is further configured to map the particular number to a resource block number within the coverage class using a hash function, wherein the resource block number identifies the resource block.

28. The apparatus of claim 25, wherein the at least one processor is further configured to:
monitor a neighboring resource block that is immediately before or immediately after the resource block in time for the device-specific control message.

29. The apparatus of claim 25, wherein, to determine the resource block for the UE based on the particular number, the at least one processor is further configured to determine a plurality of resource blocks based on the particular number,
wherein, to monitor the resource block, the at least one processor is configured to monitor the plurality of resource blocks for the device-specific control message from the base station.

30. The apparatus of claim 25, wherein the at least one processor is further configured to:
monitor a reserved resource block for the device-specific control message.
